(19) United States
(12) Patent Application Publication
(10) Pub. No.: US 2009/0037171 A1
(43) Pub. Date: Feb. 5, 2009

(54) Real-time voice transcription system

(76) Inventors: Tim J. McFarland, Lansing, MI (US); Vasudevan C. Gurunathan, Morrisville, PA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/222,164

(22) Filed: Aug. 4, 2008

Related U.S. Application Data
(60) Provisional application No. 60/935,289, filed on Aug. 3, 2007.

(51) Int. Cl. G10L 15/26

(52) U.S. Cl. 704/235; 704/E15.001

(57) ABSTRACT

The real-time voice transcription system provides a speech recognition system and method that includes use of speech and spatial-temporal acoustic data to enhance speech recognition probabilities while simultaneously identifying the speaker. Real-time edit capability is provided enabling a user to train the system during a transcription session. The system may be connected to user computers via local network and/or wide area network means.

### CROSS-REFERENCE TO RELATED APPLICATION

This application claims the benefit of U.S. Provisional Patent Application Ser. No. 60/935,289, filed Aug. 3, 2007.

### BACKGROUND OF THE INVENTION

1. Field of the Invention

The present invention relates to automated voice transcription, and more particularly to a real-time voice transcription system having real-time editing capability.

2. Description of the Related Art

In trials, depositions, committee meetings, and public hearings, it is desirable to have a transcript of the proceedings. Often it is necessary to have such a transcript as soon as possible. However, transcription is usually done manually from stenotype records or from audio tapes. It is difficult to automate the process, particularly when there are many speakers, so that machines cannot distinguish one speaker from another. It would be beneficial to have an automated system that provides for transcription of oral proceedings in real-time, with or without real-time editing.

Thus, a real-time voice transcription system solving the aforementioned problems is desired.

### SUMMARY OF THE INVENTION

The real-time voice transcription system provides a speech recognition system and method that includes use of speech and spatial-temporal acoustic data to enhance speech recognition probabilities while simultaneously identifying the speaker. Real-time editing capability is provided, enabling a user to train the system during a transcription session. The system may be connected to user computers via local network and/or wide area network connections.

These and other features of the present invention will become readily apparent upon further review of the following specification and drawings.

### BRIEF DESCRIPTION OF THE DRAWINGS

FIG. 1 is a block diagram of a network environment for a real-time voice transcription system according to the present invention.

FIG. 2 is a block diagram showing the relationship between various client side components of the real time voice transcription system according to the present invention.

FIG. 3 is a block diagram showing the primary modes and functions of the transcription system according to the present invention.

FIG. 4 is a schematic drawing showing processes accessible through a CAT subsystem of the transcription system according to the present invention.

FIG. 5 is a flowchart of the real time voice transcription system according to the present invention.

FIG. 6 is a flowchart of the transcription process of the real time voice transcription system according to the present invention.

FIG. 7 is a block diagram showing detail of the real time voice transcription system of the UI layer according to the present invention.

FIG. 8 is a flowchart of the CART transcription process of the real time voice transcription system according to the present invention.

FIG. 9 is a representative screen shot of the proceeding creation page of the real time voice transcription system according to the present invention.

FIG. 10 is a representative screen shot of the session creation page of the real time voice transcription system according to the present invention.

FIG. 11 is a representative screen shot of the participant creation page of the real time voice transcription system according to the present invention.

FIG. 12 is a representative screen shot of the user type creation page of the real time voice transcription system according to the present invention.

FIG. 13 is a representative screen shot showing proceeding management selections of the user type creation page of the real time voice transcription system according to the present invention.

FIG. 14 is a representative screen shot showing the File drop down menu selections of the real time voice transcription system according to the present invention.

FIG. 15 is a representative screen shot showing user type entry field of the user type creation page of the real time voice transcription system according to the present invention.

FIG. 16 is a representative screen shot showing participant name and display name entry fields of the real time voice transcription system according to the present invention.

FIG. 17 is a representative screen shot showing the participants entry boxes of the session creation page of the real time voice transcription system according to the present invention.

FIG. 18 is a representative screen shot showing the session options menu of the session creation page of the real time voice transcription system according to the present invention.

FIG. 19 is a representative screen shot showing an option dialog box of the real time voice transcription system according to the present invention.

FIG. 20 is a representative screen shot showing a role drop down menu of the real time voice transcription system according to the present invention.

FIG. 21 is a representative screen shot showing a microphone drop down menu of the real time voice transcription system according to the present invention.

FIG. 22 is a representative screen shot showing Q&A session of the real time voice transcription system according to the present invention.

FIG. 23 is a representative screen shot showing Q&A session of the real time voice transcription system according to the present invention.

Similar reference characters denote corresponding features consistently throughout the attached drawings.

### DETAILED DESCRIPTION OF THE PREFERRED EMBODIMENT

The present invention provides a speech recognition system and method that includes use of speech and spatial-temporal acoustic data to enhance speech recognition probabilities while simultaneously identifying the speaker. Real-time edit capability is provided enabling a user to train the system during a transcription session.

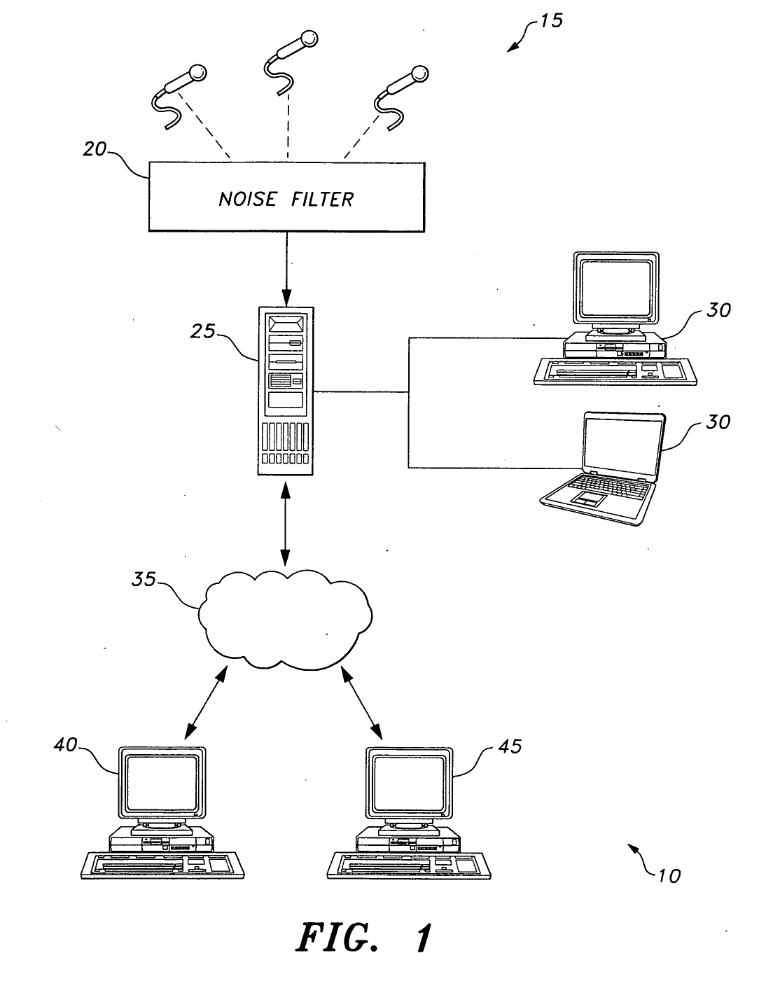

As shown in FIG. 1, the system 10 may be connected to user computers 30 via local network and/or user computers 40 and 45 via wide area network, such as the Internet 35. Transcription software may execute in server 25 and takes audio input from at least one microphone 15 via noise filter 20.

Multiple voice recognition profiles can be simultaneously executed in the server 25 while immediately translating the spoken word to text. Through a variety of techniques known by those of ordinary skill in the art, the software can determine who is speaking by the connection of the microphone and/or by the volume level of that microphone. The system 10 is capable of holding text in a buffer whenever a second speaker interrupts a first speaker whose speech is being transcribed by the system 10. The system 10 is capable of transcribing a single voice for captioning for deaf students and television news broadcasts as well as inputs from multiple voices. Real time translation and editing of the real time text for immediate delivery of transcription is provided by the system 10.

Additionally, the system 10 can be used with CART (Communication Access Real Time) for deaf or hard of hearing students. Additionally, a feature is provided that allows a student to communicate with a professor by typing on the student's keyboard and having the typed text appear in a dialog box on the professor's computer. The typed text can also be sent as an audio signal so as to notify the user (professor) that a question has been posted so other students and the professor can hear the question.

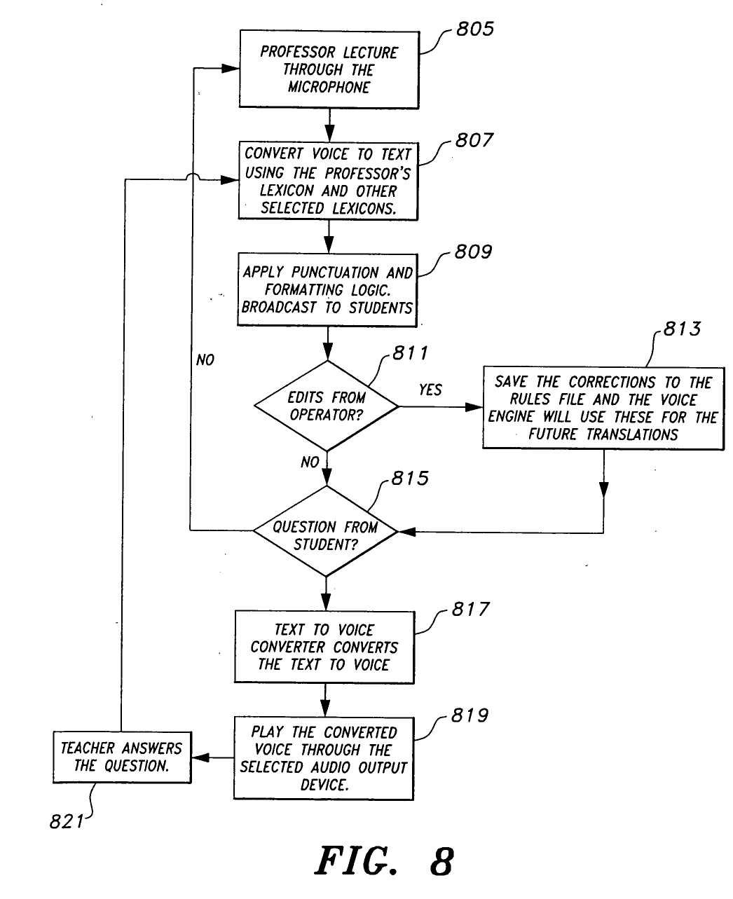

For example, as shown in FIG. 8, the system 10 can accept speech input from a lecturing professor at step 805. At step 807 the voice is converted to text by using at least one lexicon adapted to the professor's speech. At step 809, punctuation and formatting logic is applied to the transcribed speech and broadcast to students. A court reporter/computer operator is given the opportunity to edit the transcription at step 811. As shown at step 813, if edits are received, the system 10 saves the corrections to a rules file and the voice engine will use the corrections for future translations.

Subsequently, at step 815 the system monitors for questions from the students. If there are no questions, the normal transcription procedure continues. Otherwise, at step 817 a text to voice converter converts the text to voice. At step 819, the converted voice is transmitted via playback means through a selected audio output device. At step 821 the system 10 pauses the playback to allow the teacher to answer the question.

In addition to a standard computer keyboard, the system 10 has an interface for connecting a stenograph machine to the computer 25 via serial or USB ports, and a series of edit commands are provided that can be invoked from the stenograph keyboard. The system 10 is capable of broadcasting over the Internet 35 or using the Internet 35 to send audio and video to a remote site 40 or alternative remote site 45 for remote translation and/or editing and for remote viewing and listening.

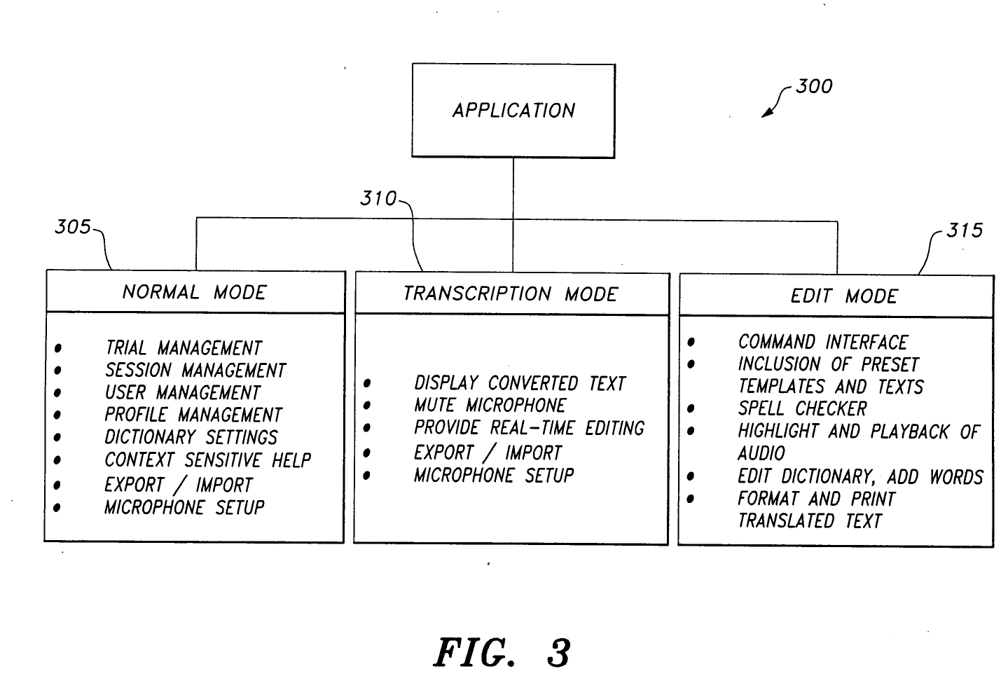

The basic functionality of the system 10 is a voice recognition transcription system that displays text in a user-friendly interface. As shown in FIG. 3, the application 300 provides functions/modes for the user to define un-translated and mistranslated voice to proper text. Primary modes of the system 10 include a normal mode 305, a transcription mode 310, and an edit mode 315.

The normal mode 305 provides for proceeding management, session management, user management, profile management, dictionary settings, context sensitive help, export and import of files, and microphone setup.

The transcription mode 310 provides for displaying converted text, muting the microphone, as required, providing real-time editing, export/import of files, and microphone setup.

The edit mode 315 provides a command interface, inclusion of presets, templates, text, and a spell checker. Additionally, in the edit mode 315, text can be highlighted and the audio/video can be played back. A dictionary can be edited wherein words can be added. Speech converted to text can be formatted and printed.

The application 300 has the basic functions of a word processor plus an “add question feature” with facilities for the user to insert additional information to any part of the text. Additionally, the system 10 keeps track of the inserted information by color and font coding of text according to speech originating from different speakers.

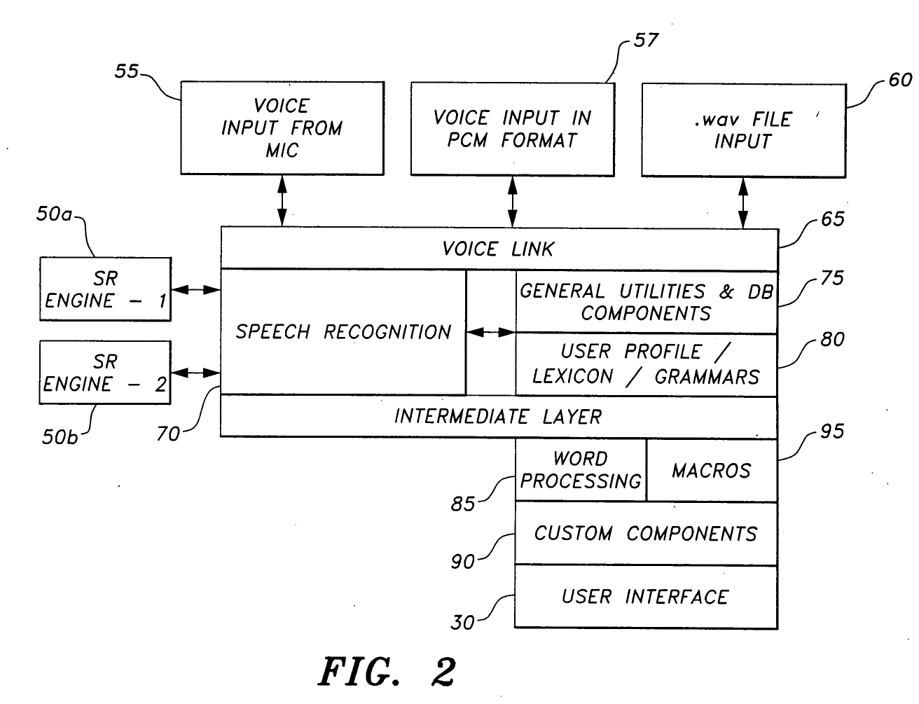

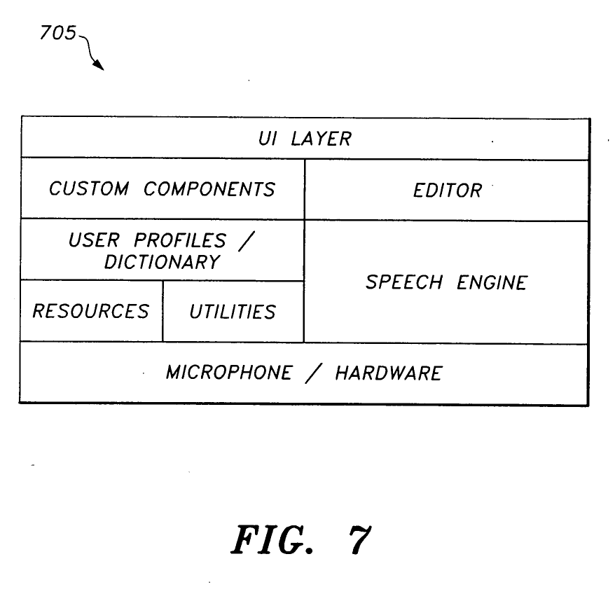

As shown in FIGS. 2 and 7, the system has layered interconnections for management of both hardware and software components. Microphone voice input 55 can be accepted by a voice link function 65. The voice link function 65 is also capable of accepting PCM formatted voice input 57 and WAV file input 60. The voice link 65 provides an interface between the aforementioned speech input types and the speech recognition layer 70, as well as the general utilities and database components layer 75. A plurality of speech recognition engines such as first SR engine 50a and second SR engine 50b can be in operable communication with the speech recognition layer 70. Layer 80 comprises user profile, lexicon, and grammars, and provides an interface between the utilities/database layer 75 and word processing functions 85, in addition to macros 95. User interface 30 is in operable communication with custom components layer 90 to provide access to word processing function 85 and macros 95. UI layer detail 705 illustrates the detailed components of which the UI layer 30 is comprised.

The system 10 will operate in any operating system environment including Microsoft Windows, Linux, Unix or MAC. The software can be installed on a PDA to provide the ability to translate speech to text, whereby the doctors can dictate medical records or reports. After the dictation is completed a text file can be uploaded to a local host computer or to an off-site, remote processing center for finalization. This process can also be performed on the PDA if so desired. Any additions to the profile/dictionary that are made, either on the PDA or host computer, can be uploaded to the other device. This process ensures a more accurate record with each subsequent use.

Again referring to FIG. 1 which illustrates an example of a suitable computing system environment 10 in which the present invention may be implemented, the computing system environment 10 is only one example of a suitable computing environment and is not intended to suggest any limitation as to the scope of use or functionality of the invention. Neither should the computing environment 10 be interpreted as having any dependency or requirement relating to any one or combination of components illustrated in the exemplary operating environment 10.

Software implementing the procedures, systems and methods described herein can be stored in the memory of any computer system as a set of executable instructions. In addition, the instructions to perform procedures described herein could alternatively be stored on other forms of machine-readable media, including magnetic and optical disks.

For example, methods described herein may be stored on machine-readable media, such as magnetic disks or optical disks, which are accessible via a disk drive (or computer-readable medium drive). Further, the instructions may be downloaded into a computing device over a data network in a form of compiled and linked version.

Alternatively, the logic could be implemented in additional computer and/or machine readable media, such as discrete hardware components as large-scale integrated circuits (LSI's), application-specific integrated circuits (ASIC's), or firmware such as, for example, electrically erasable programmable read-only memory (EEPROM's), and the like.

Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can be accessed by a computing system such as exemplary server 25. Any such computer storage media may be part of server 25. Moreover, the inventive program, programs, algorithms, or heuristics described herein can be a part of any computer system, any computer, or any computerized device.

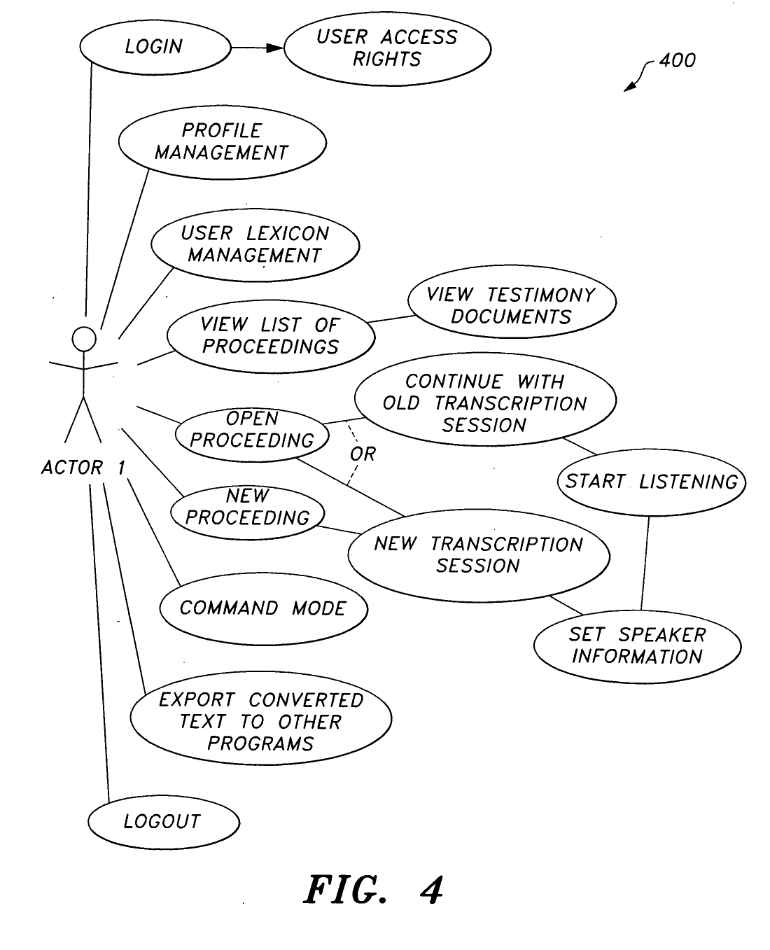

As shown in FIG. 4, the system 10 provides a user, such as a court reporter, designated in FIG. 4 as ACTOR 1, access to a plurality of system management functions 400. Within system management functions 400, a user is provided with login and logout capabilities. While logged in, the user is provided with access to: access rights management, profile management, user lexicon management, a proceedings list view, testimony documents view, proceeding or session initiation function, old transcript continuation function, listening function, new proceeding/session function, new transcription session initialization function, speaker information setting function, command mode function, and a converted text export function.

The system 10 can transcribe dialogue in hearings, depositions, trials, and a plurality of other dialogue settings. During transcription, the system 10 accepts corrections of any unrecognized voice patterns in real time transmitted to it by a court reporter/computer operator. Once a particular pattern has been corrected in this manner, the software will automatically correctly transcribe the pattern for all subsequent occurrences.

The system 10 can transcribe multiple voices even when spoken concurrently at different microphones 15 and identify each speaker separately as the voices are buffered within the computer 25. Multiple channels may be used for this feature. Another option can be to select that all participants are translated and displayed on the screen with a space between each participant when more then one speak at the same time. When one participant stops speaking, the blank space between speakers automatically disappears. The text is in different colors for each speaker making it immediately apparent who is speaking.

The system 10 translates in real time and displays the text in an interface that allows for a court reporter/computer operator to edit the translation as it is taking place. When a new text is defined for a mistranslated or un-translated voice, this data is stored in a default rules or user selected rules file and, going forward, the translation will use the new definition.

The system 10 may have a plurality of USB ports and real time and the speaker is identified only once to the application. The system allows the user to see the text, and edit the same in real time and the user is able to define unrecognized voice, which will be used for subsequent translation.

The system 10 uses multiple speech engines and the operator can select the best engine 50a, 50b, or the like, for a speaker providing the highest rate of translation. The system 10 may use off-the-shelf technology such as the Microsoft® speech engine. The system 10 has the ability to set decibel levels at each microphone 15 so that only the expected voice from each microphone 15 is recorded. This eliminates the possibility of picking up ambient noise or voices from unwanted sources.

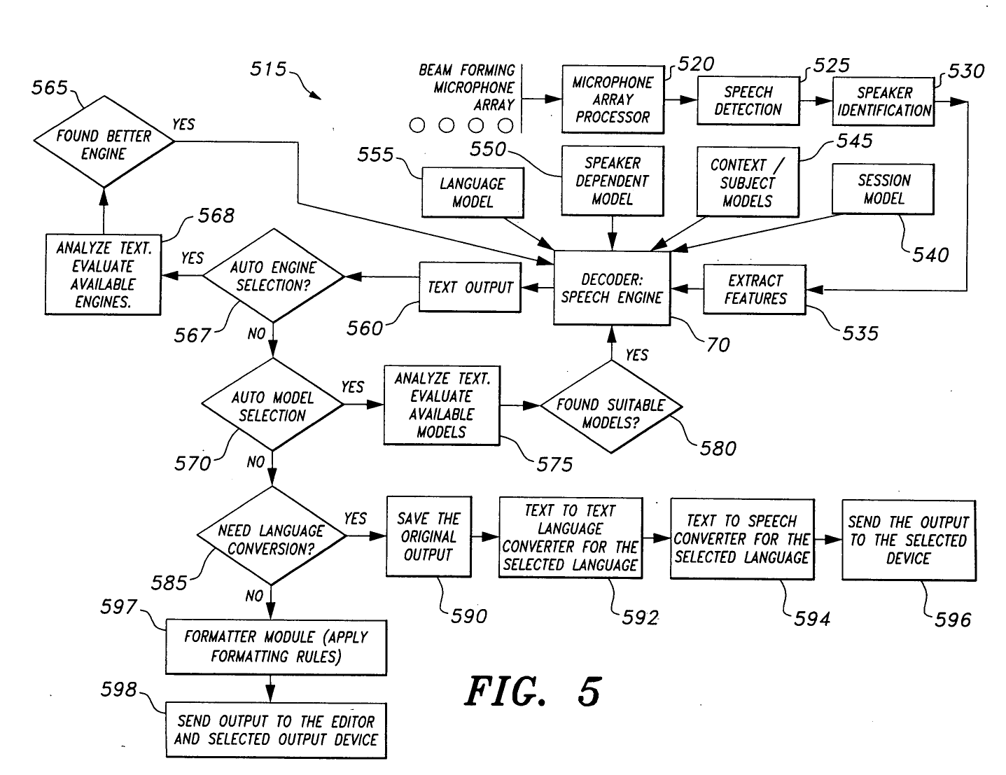

As shown in FIG. 5 a microphone array can provide input to a microphone array processor 520. The microphone array forms a directive pattern or beam. A microphone array processor 520 can be used to steer the microphone array electronically to all directions simultaneously without any a-priori information about a signal's direction. Output of the microphone array processor 520 is further processed at 525 to determine whether speech is present in the signal from the microphone/microphone array. Speaker identification processor 530 identifies the speaker. At each time frame, microphone array processor 520 can steer a beamformer to all directions while the speaker identification processor 530 can extract acoustic feature vectors from each direction. Matching is then performed between the extracted feature vectors and acoustic models representing the various speakers for positive speaker identification.

Moreover, as known by those of ordinary skill in the art, a Viterbi search may be performed in a 3-D trellis space composed of input frames, direction and hidden Markov models (HMMs) to obtain a path with the highest likelihood. The path is a q,d, i.e., (state, direction), which corresponds to the uttered speech and talker locus. Therefore the talker localization and speech recognition can be performed simultaneously. The (q,d) having the highest likelihood can be obtained using HMM models and an observation vector sequence. The probabilities of each (q,d) at the time frame can be computed using state and direction transition probabilities. The state transition is provided by the acoustic models. The direction transition probability that indicates movement of the talker is computed using a heuristic approach.

Additional audio features related to the speaker and ambient sound are extracted via features extraction processor 535. Output of features extraction processor 535 is accepted by decoder speech engine 70. Additional inputs to the decoder speech engine 70 include a language model 555, a speaker dependent model 550, a plurality of context/subject models 545 and a session model 540.

When text output is produced, a formatter module 597 formats the text according to formatting rules stored in the system 10. A user selected output device accepts the formatted output sent by text output transmitter 598. If the court reporter/system operator has selected automatic speech engine selection 567, a text analyzer and speech engine evaluator 568 performs an analysis on the output text, and if a better speech engine is found a speech engine selector 565 sends that information to the speech engine module 70 which then utilizes the superior speech recognition engine.

Additionally, if automatic model selection has been selected 570, text analyzer/model evaluator 575 directs the speech engine 70 to utilize the superior model if found at step 580.

Moreover, according to language decision module 585 if a language conversion is needed, the original output is saved at step 590 and text to text language processor 592 converts a copy of the original output to the target language upon which text to speech converter 594 outputs to a selected output device 596.

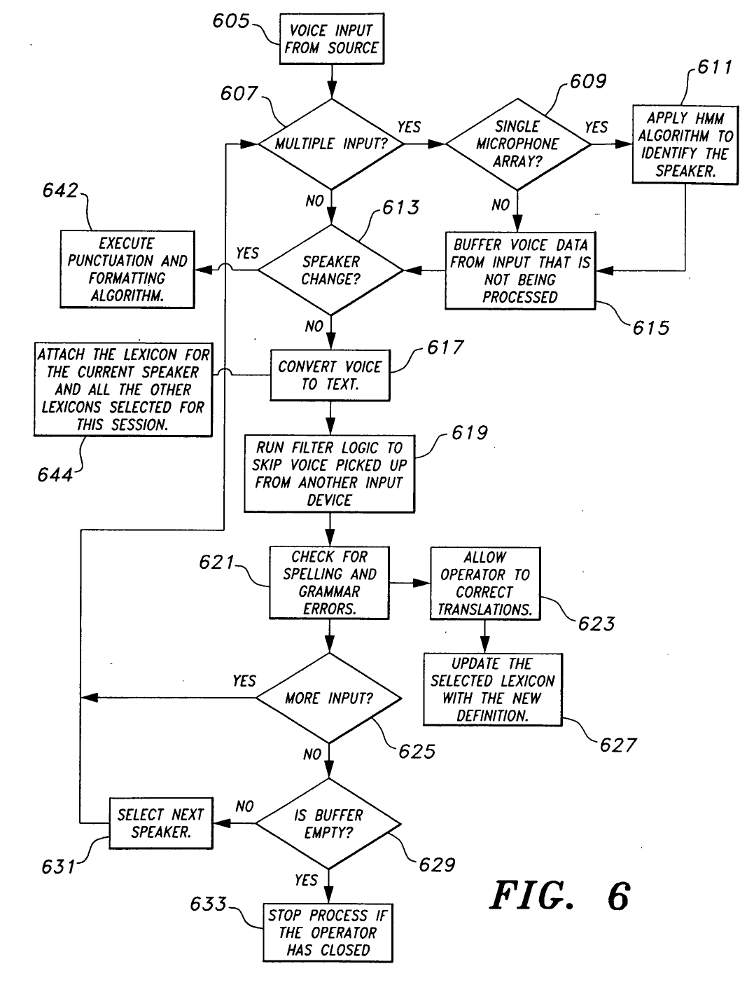

As shown in FIG. 6, the inventive speech to text processing algorithm comprises step 605, which accepts voice input from a source. At step 607, if there are multiple speech inputs, a determination is made at step 609 if the multiple inputs are coming from a single microphone array.

In the single microphone array instance, a hidden Markov model (HMM) is applied to identify the speaker at step 611. In any event, voice data from input that is not being processed is buffered at step 615. At step 613 a determination is made whether the speaker has changed. If not, the voice is converted to text at step 617. If the speaker has changed, punctuation and formatting changes to indicate the new speaker are executed at step 642.

At step 644, a specific lexicon is attached and associated with the current speaker. Additional session specific lexicons may also be attached. At step 619 filter logic is applied to skip any voices picked up that are not associated with the specific input device currently being processed. At step 621 grammar and spelling errors are checked. At step 623, the system accepts operator input of corrections to the translation. At step 627, responsive to the operator inputted corrections, the system updates the selected lexicon with the new definition. At step 625 if there is more input the process loops back to step 607 to accept the additional input. If there is no more input and the speech buffer is empty at step 629, then processing terminates at step 633. Otherwise the next speaker is selected at step 631.

The system 10 supports real time and batch mode of voice recognition, another major exception being that the system allows the court reporter/computer operator ACTOR 1 to edit the transcript in real time. In legal proceedings, the court reporter/computer operator will select the profile/dictionary of the person that is asking questions. At that point in the transcript the system will automatically insert the correct formatting, i.e., where “Direct Examination,” “Cross Examination,” and other types of examinations begin.

It is also possible to connect a stenotype machine to the computer 25 and edit the text using predefined commands recognized by the court reporter's personal dictionary.

When only one microphone 15 is available, a method of predetermining or assigning different voices or voice types to a particular profile/dictionary is available. The system 10 automatically determines which dictionary to translate against and will identify the speaker accordingly, i.e., in colloquy, it will display the name of the speaker in the format preset by the court reporter/computer operator. During Q&A, the system will put a “Q” at the beginning of each question and an “A” at the beginning of each answer. A user profile/dictionary can also be selected if one exists for an individual participant. Punctuation is inserted automatically by the implementation of logic using rules stored in the system 10.

While real time is taking place, a court reporter/computer operator, can make corrections and define incorrect voice translations and have those corrections apply to all future translations. The corrections only apply to the profile/dictionary that was opened at that particular point in the transcript. As corrections are made and parentheticals (unspoken text) are inserted by the court reporter/computer operator, the system 10 can refresh each connected computer accordingly. The system 10 has a list of all parentheticals, which can be selected for automatic insertion in the transcript.

Each connected computer, such as computers 30 or computers 40 and 45 has the option of receiving a signal from the translating computer 25 or viewing the translated text on the computer processing the voice translations. This can be done by hard wire, wireless signal or over the Internet 35. A signal can be sent out through a USB port so that the system 10 will have the capability to do open and closed captioning for television stations and companies that provide services to meeting planners. The system 10 can also be used for CART when one or more than one computer is being utilized.

The system 10 can accept language translation commands and will translate from one language to another as required. The audio/video and transcript are synchronized files stored on a hard disk of the computer processing the voice translation and also on the remote computers if the option is selected. This makes it possible to select any portion of the text for playback when a participant in the proceedings asks for the record to be read back. This is also possible from remote computers receiving the signal. The system 10 can be operated with or without selecting a profile/dictionary before beginning translation. The profile/dictionary can be created in real-time or in a post-production mode by entering vocabulary or translations to one or multiple profiles/dictionaries while in the “edit” mode. The entries are made by the court reporter/computer operator as the editing process takes place. The system can translate against a universal profile/dictionary or individual profiles/dictionary. All profiles/dictionaries have the ability to adapt to different accents. The system 10 will select the data from an individual dictionary and if not found will access the universal dictionary.

The system allows each participant to select a desired language environment for the text to be displayed on that participant's terminal. The transcription will take place on one computer while the lecturer is speaking and if the student types in a question on his/her computer, the computer will speak it for the lecturer to answer. This is a very helpful tool while dealing with handicapped students. The system 10 provides a male or female voice from which the student can choose. The transcription to be executed in a computer, PDA or other processing device with voice recording capability and transferred via hard wired/wireless network to a back office computer where it will be validated by a transcriber. This will work under windows CE or other operating systems. Any correction made in the computer or in the back office to correct any unrecognized voice patterns can be uploaded back to the PDA and next time the percentage of unrecognized voice patterns will be less.

A form filler is provided where the user has a standard form that is used that is filled out by long hand and after the fact, manually input into a computer system. The form filler is provided on a computer, PDA or other electronic device used to convert voice-to-text. There are standard forms that can be created or scanned into the system 10. Each form may have item fields that can be filled out, these can include; name, date, time as well as answers to a series of the same questions for each interview. The system 10 can go to a preset field when a key associated with the field is depressed. An example would be that the user wants to go to the “name” field, the CTRL key is depressed and the word “name” would be spoken, the system immediately jumps to the “name” field and the user speaks the name and the name automatically appears in the field. Each field is also represented by a character and can be accessed by depressing the designated key for a particular field. This process is then repeated for all fields eliminating the necessity to manually input the information at a post-interview time. Examples of uses for this product are; interview elderly patients for medical history reports at nursing homes or for home health care, job interviews, hospital admissions, etc.

The system 10 provides a plurality of features for locating important areas of the transcript, such as automatic search and extraction <substantive> issue coding or events as to when exhibits are marked, a witness is sworn in, ruling by a judge, or the like. Because the system 10 automatically synchronizes the text with the audio/video, via time code/frame sync either can be played by selecting the event or text desired. These events can be saved and later played back in any order desired by the user.

The system 10 has the ability to print the transcript in any desired format, i.e., multiple lines per page, adjust line spacing, adjust margins, page numbering, etc. The system 10 also can generate and print a concordance of all words in the transcript. The printout can be adjusted to any required format.

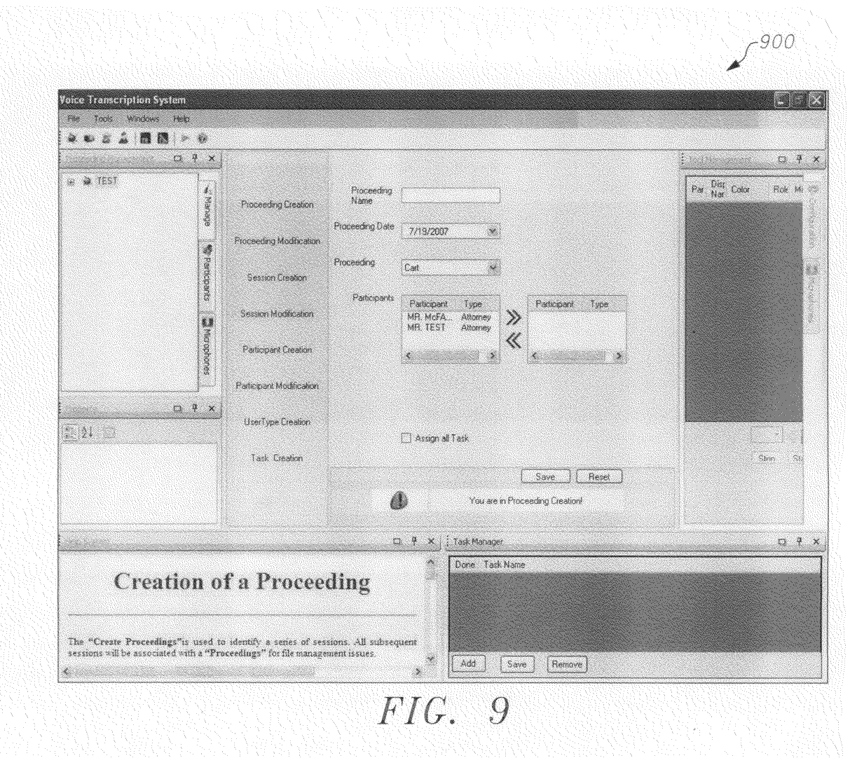

Screenshots illustrating the operator user interface are presented in FIGS. 9-23. As shown in FIG. 9 the system can provide a graphical user interface comprising a proceeding creation page 900. On this page, proceedings may be built or modified; sessions may be built or modified; a list of participants may be built or modified; a user type may be assigned, and a task list may be created.

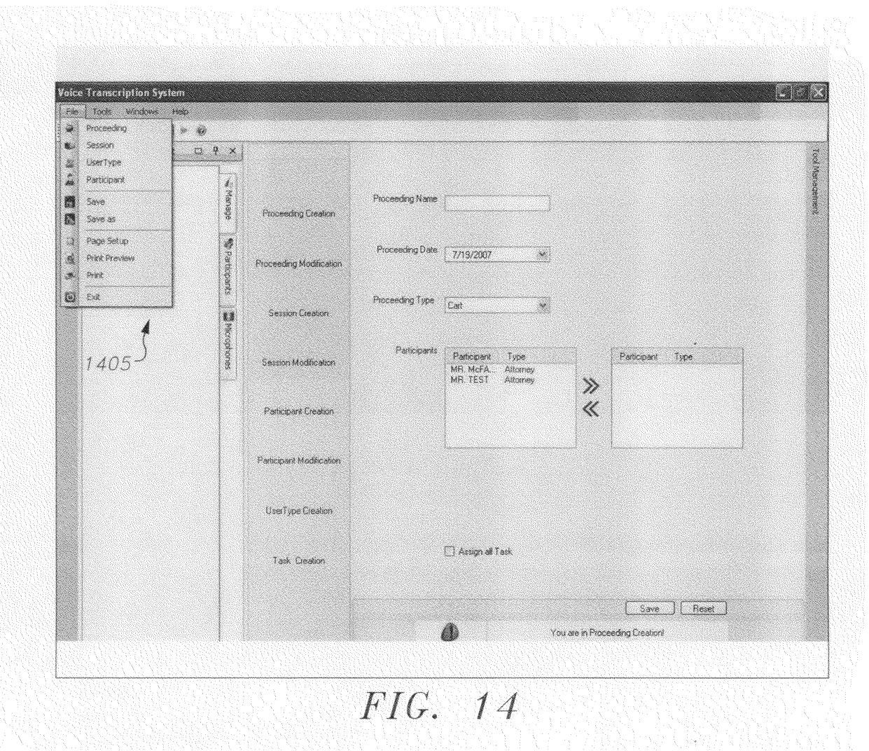

As shown in FIG. 14, a drop down menu 1405 comprising Proceeding, Session, User Type, and Participant is available for the user to select. As shown in FIGS. 9 and 14, it should be noted that the proceeding type may be accessed via a pull down menu. The exemplary proceeding shown is a CART type proceeding. Proceeding types that may be created in this manner include, but are not necessarily limited to, CART, Deposition, Trial, Meeting, Hearing, Arbitration, and Form Filling. Formatting rules applied by formatter module 597 vary according to the proceeding type selected by the user.

For example, Deposition and Trial proceeding types may have a colloquy format type with “Q:” or “A:” preceding the transcribed speech depending on a role of the identified speaker in the transcription. As shown in FIG. 9, the user has created two participants and assigned their type using the User Type Creation button. Users and their types are displayed in the left hand participants box, however, to activate these participants for a given session, they must be transferred over to the right hand participant box. To deactivate participants for a given session, the reverse procedure is done. The Double arrow transfer buttons are used to accomplish the transfer from left hand box to right hand box and vice versa.

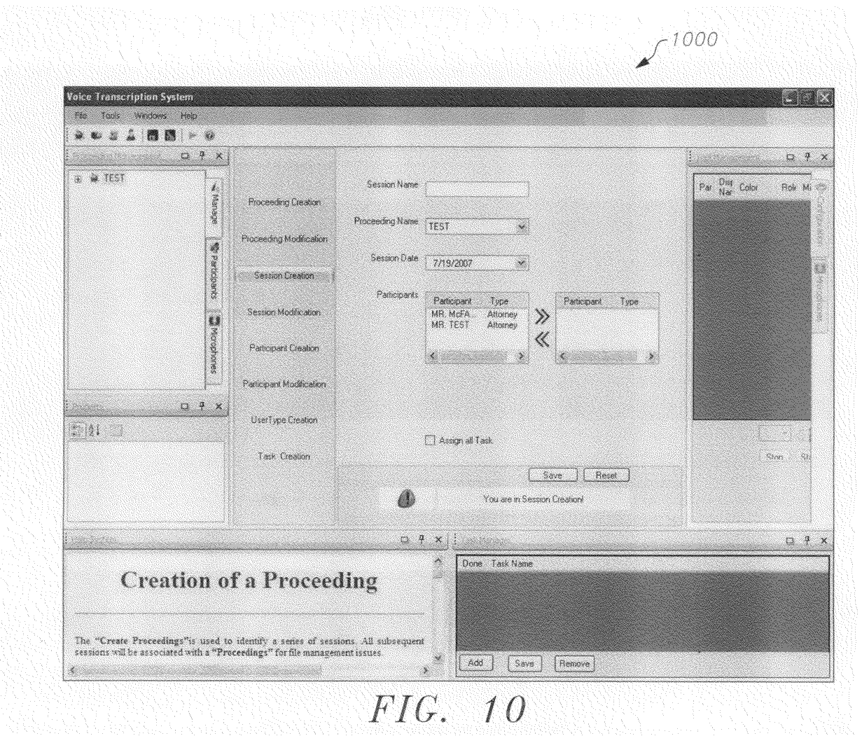

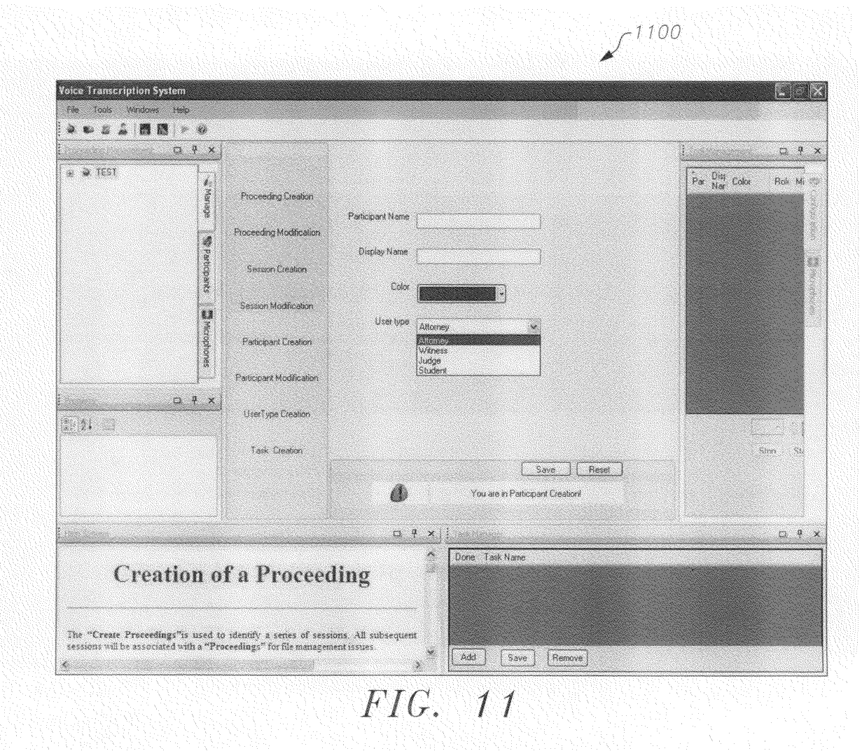

As shown in FIG. 10, when a user is in the session creation mode 1000, an indicator message, such as, “You are in Session Creation!” may be presented. Note that, as shown in FIG. 11, presentation color options page 1100 provides the user with the option to select a font color for a particular type of user.

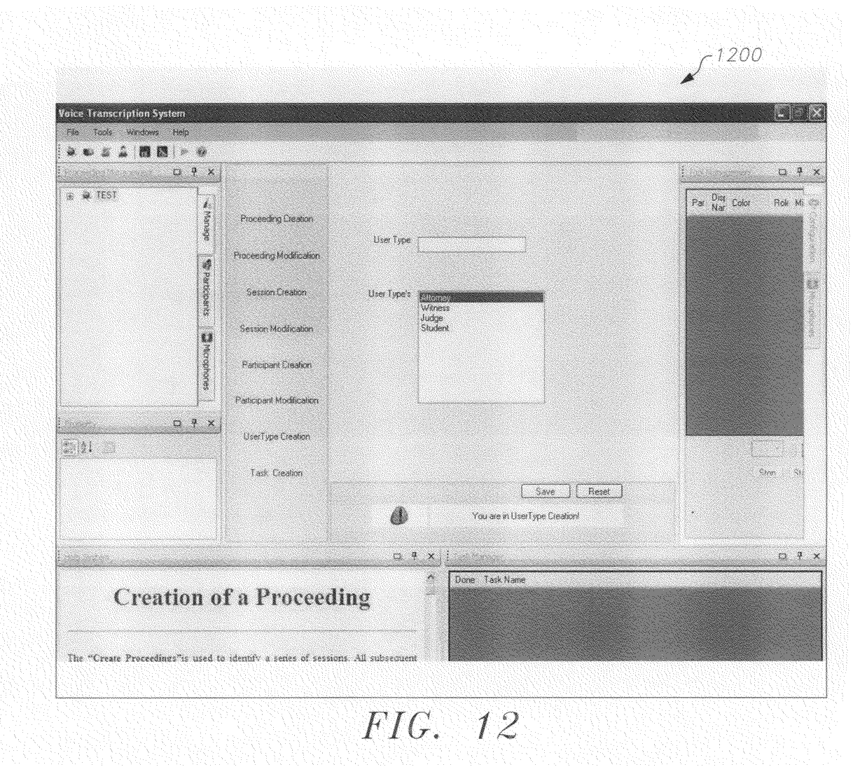

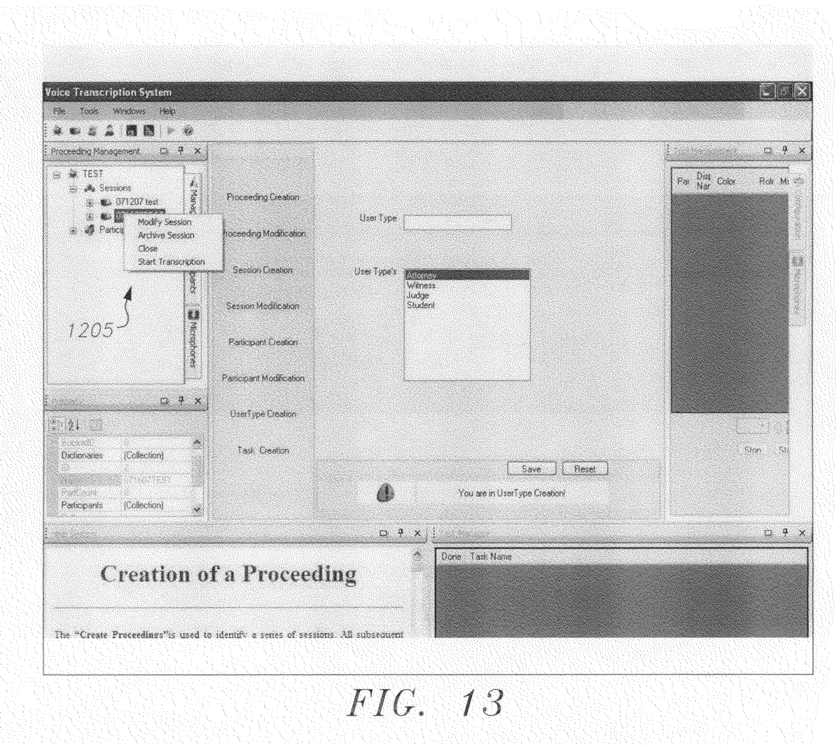

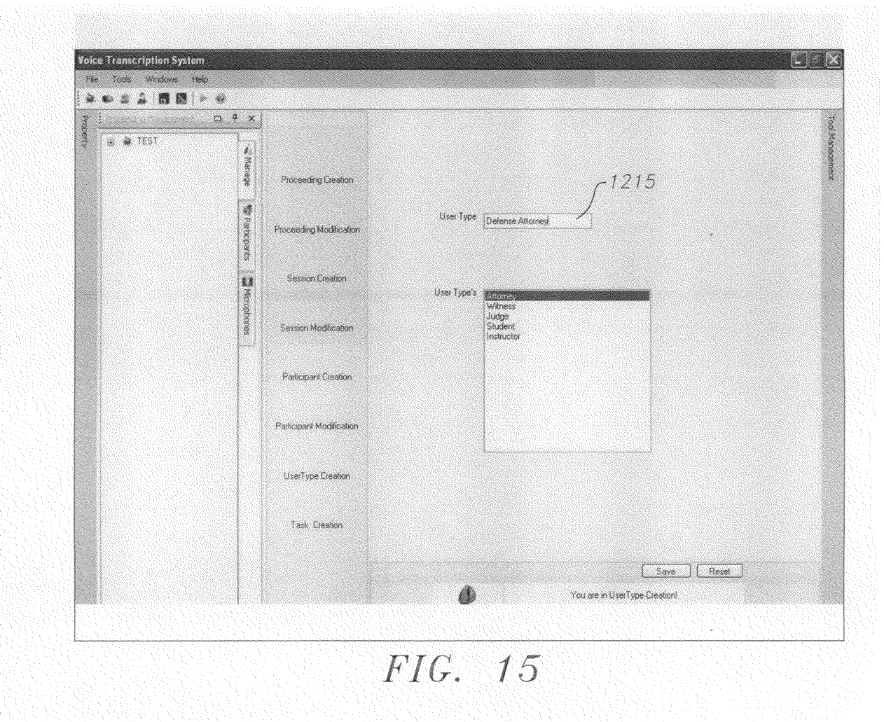

FIG. 12 illustrates the UserType Creation page 1200. In the UserType Creation page 1200 user types, such as “Attorney” “Witness”, “Judge”, “Student”, or the like are presented to the user for selection. As shown in FIG. 13, during user type creation, a session can be identified in which a drop down menu 1205 is presented to give the user an opportunity to modify, archive, or close a session, or to start a transcription. As shown in FIG. 14, during proceeding creation, the user can access the File menu 1405 for various management operations, including saving or printing the work created on the proceeding creation page. As shown in FIG. 15, a user type, such as “Attorney”, or the like, may be modified in a User Type entry box 1215. The exemplary modified entry is “Defense Attorney”.

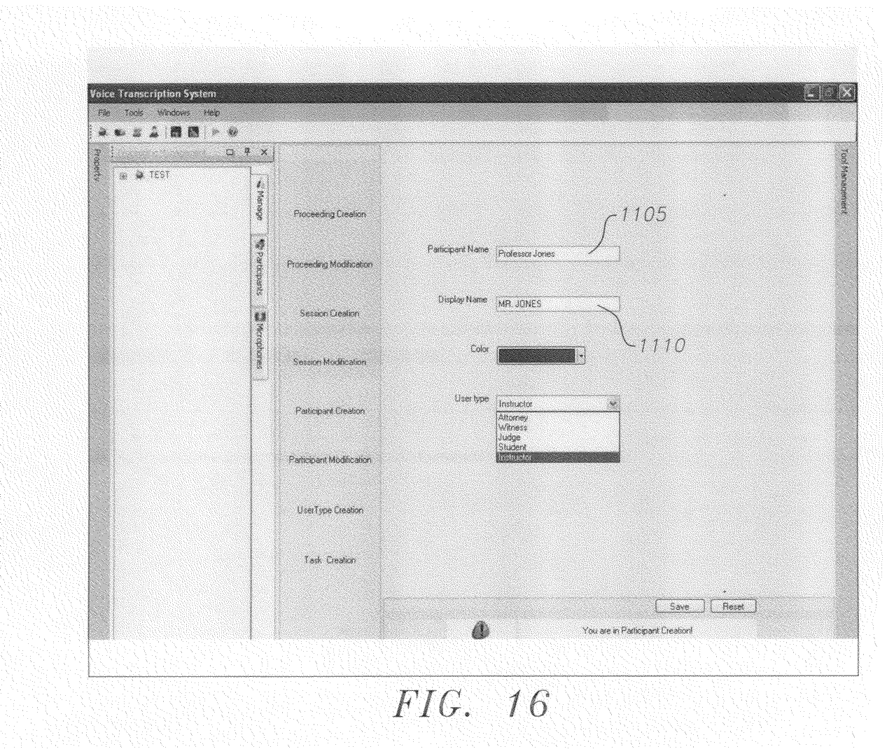

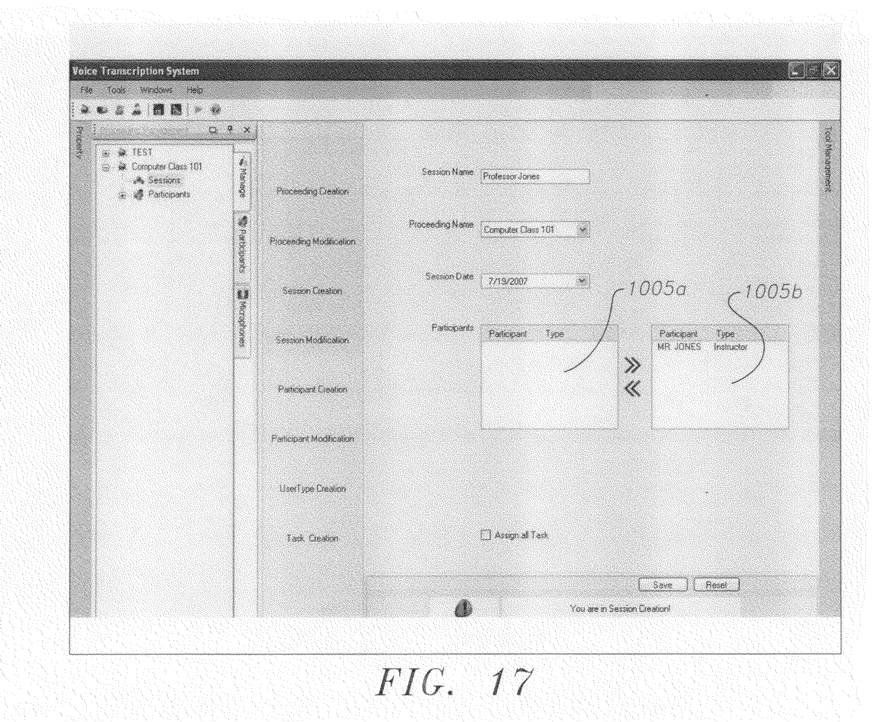

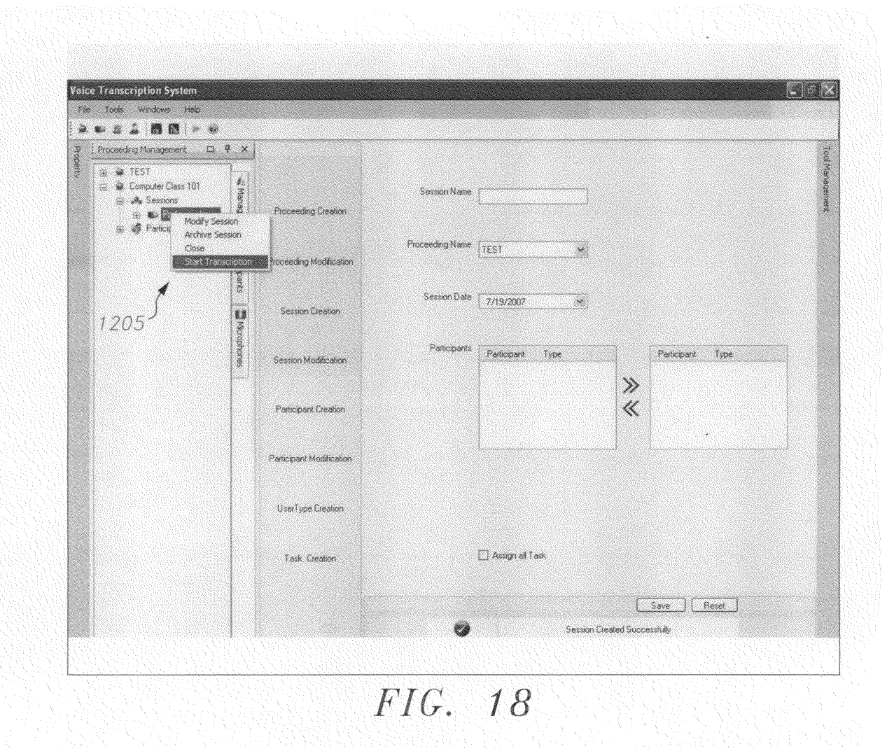

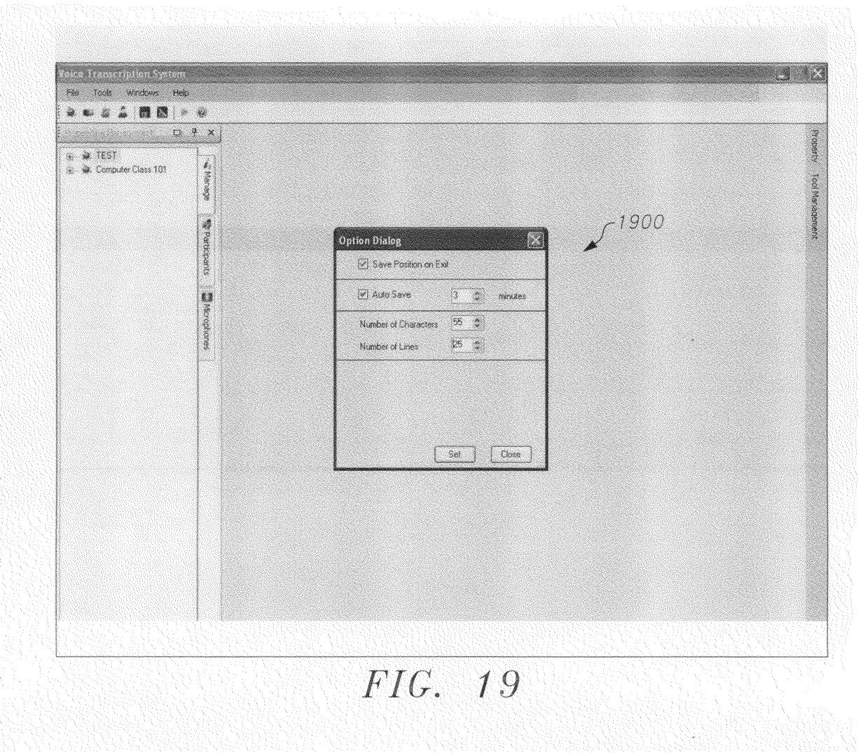

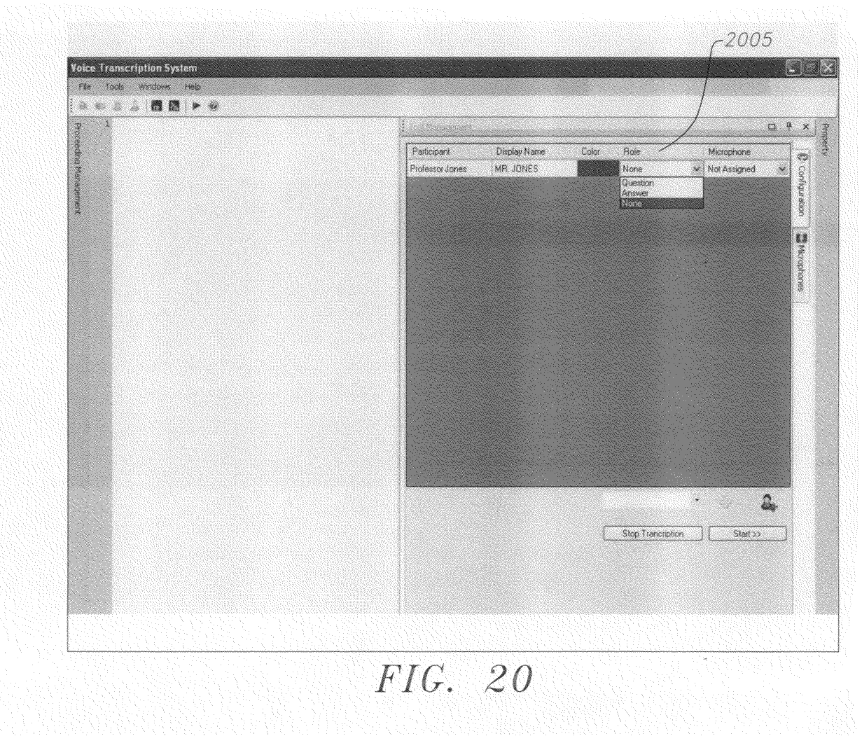

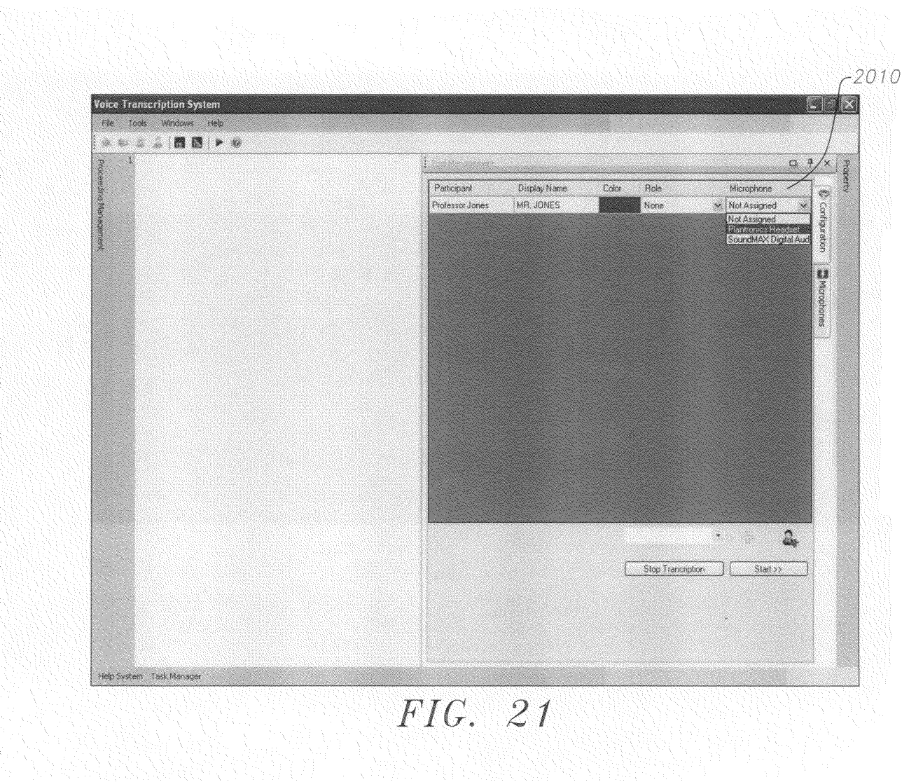

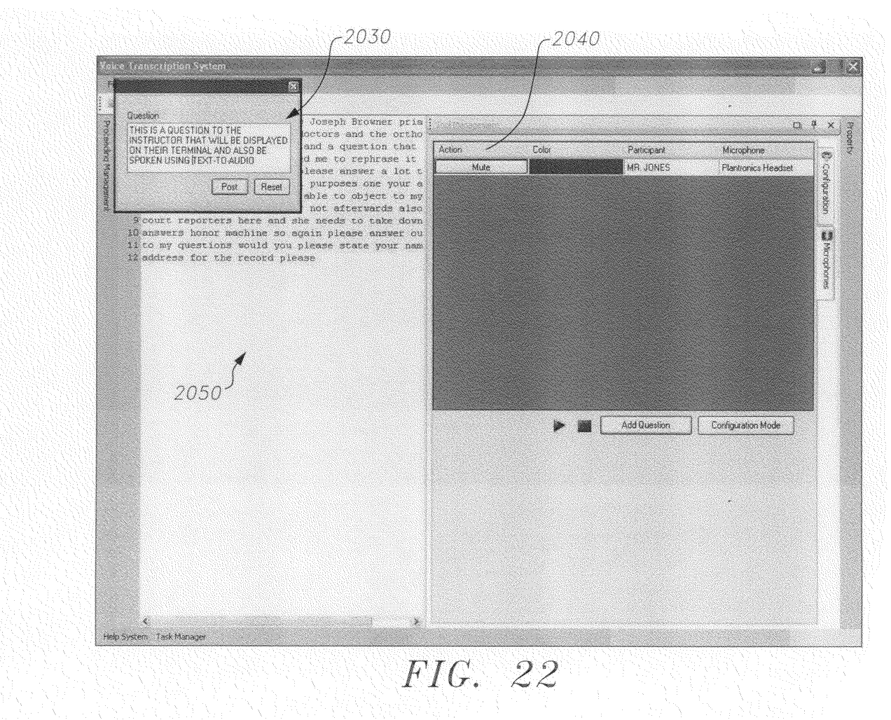

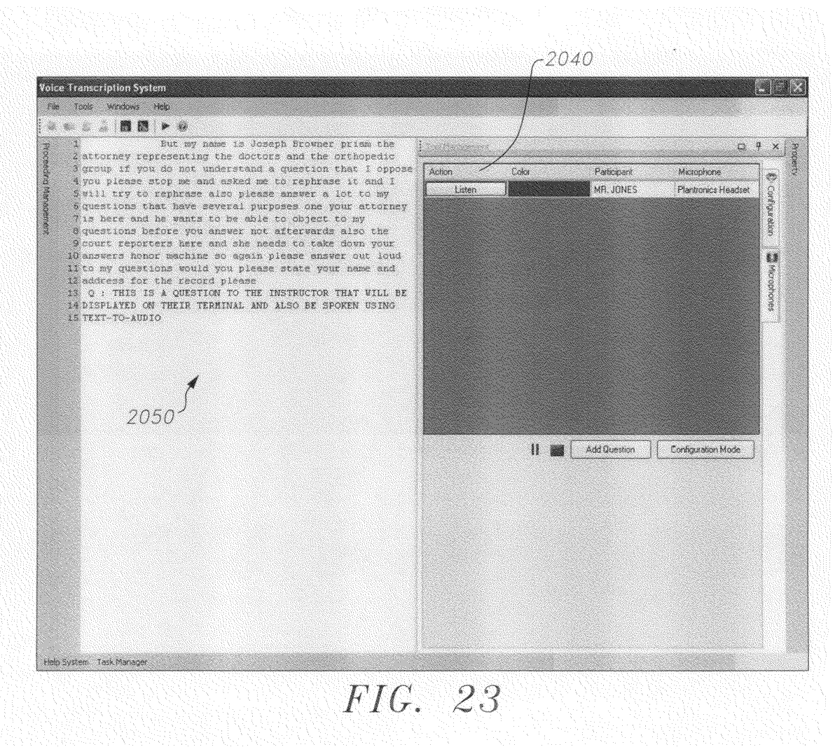

As shown in FIG. 16, during participant creation, a participant name field 1105 and a display name field 1110 are presented for user entry. FIG. 17 illustrates recently transferred participant and type from the left hand box Participant setup box 1005a to the right hand Participant active box 1005b, indicating that “Mr. Jones”, having a role of “Instructor” is active for the current session. As shown in FIG. 18, from the Proceeding Management column, proceeding management drop down menu 1205 is provided from which a user may start the transcription. FIG. 19 illustrates an option dialog box 1900 from which characters per line, lines per page, and save options may be selected by the user. As shown in FIG. 20, if a Q and A proceeding has been selected, the participant role 2005 may be assigned to questioner, answerer, or none. FIG. 21 illustrates the audio source pulldown menu 2010 accessible from the Microphone button. FIG. 22 illustrates a dialog box from which a student may type a question for conversion to speech to the instructor. The speech to text transcription appears in the transcription area 2050. The user can mute inputs via action button 2040. As shown in FIG. 23, alternatively the user can activate a sound source via action button 2040. The question typed in dialog box 2030 is now presented in the transcription area 2050 as a properly formatted question.

It is to be understood that the present invention is not limited to the embodiment described above, but encompasses any and all embodiments within the scope of the following claims.

We claim:

1. A real-time voice transcription system, comprising:
means for capturing audio data, the audio data including speech information;
means for extracting temporal and aural features from the captured audio data;
means for recognizing the speech information within the audio data, including means for identifying a speaker;
means for producing a transcription of the identified speaker's speech information;
means for accepting corrections to the transcription from a user;
means for analyzing the user entered corrections; and
means for improving the speech recognition in real time based on the analysis;
whereby transcription accuracy is improved on the fly.

2. The real-time voice transcription system according to claim 1, further comprising a server computer adapted for connection to a computer network, the server computer having a processor and software operable thereon, the software comprising all of said means, whereby user computers may access the transcription system via the computer network.

3. The real-time voice transcription system according to claim 1, wherein said means for identifying the speaker further comprises means for identifying the speaker from a composite signal containing a plurality of speakers.

4. The real-time voice transcription system according to claim 1, further comprising means for implementing a Hidden Markov Model for facilitating identification of the speaker.

5. The real-time voice transcription system according to claim 1, further comprising means for storing a specific lexicon, the specific lexicon being associated with the current speaker.

6. The real-time voice transcription system according to claim 5, further comprising:
means for updating the lexicon associated with the speaker based on a result of the analysis of the user-entered corrections; and
means for utilizing the updated lexicon for improving accuracy of the transcription.

7. The real-time voice transcription system according to claim 1, further comprising a plurality of speech recognition engines selectively engaged in the system and means for selecting the speech recognition engine providing the most accurate transcription of the speaker.

8. The real-time voice transcription system according to claim 1, further comprising means for linking a voice to the system, the voice linking means accepting voice data in a plurality of analog and digital voice formats for transcription by the system.

9. The real-time voice transcription system according to claim 1, further comprising means for managing proceedings, sessions, users, profiles, dictionary settings, context sensitive help, export and import of files, microphone setup, display of converted text, microphone muting as required, real-time editing, export/import of files, a command interface, preset inclusion, templates and text, a spell checker, text highlighting, audio/video playback, dictionary editing, and formatting and printing of speech converted to text.

10. The real-time voice transcription system according to claim 1, wherein the transcription produced by the system identifies each of a plurality of speakers separately and in real time.

11. The real-time voice transcription system according to claim 10, wherein the transcription text identifies each speaker by outputting the text in a unique format assigned to the speaker.

12. The real-time voice transcription system according to claim 1, further comprising means for processing a microphone array, the processing means including means for steering a signal reception pattern of a microphone array electronically to all directions simultaneously without any a-priori information about a signal's direction, wherein acoustic feature vectors are extracted from each of the directions, thereby facilitating positive identification of the speaker.

13. The real-time voice transcription system according to claim 1, further comprising language translating means, the language translating means performing a translation of an output of the speech recognition engine and sending the translation to a selected device.

14. The real-time voice transcription system according to claim 1, further comprising means for interactively responding to a user, the interactively responding means accepting text input from a first user, and then displaying and speaking the text input to a second user.

15. A computer implemented real-time voice transcription method, comprising the steps of:
capturing audio data including speech information;
extracting temporal and aural features from the captured audio data;
recognizing the speech information within the audio data;
identifying a speaker during the speech recognition, the speaker identification being facilitated by using the extracted features obtained from the extracting step;
producing a transcription of the identified speaker's speech;
accepting corrections to the transcription from a user;
analyzing the user entered corrections; and
improving the speech recognition in real time based on the analyzing step.

16. The computer implemented real-time voice transcription method according to claim 15, further comprising the steps of:
associating a specific lexicon with the current speaker;
updating the lexicon associated with the speaker based on a result of the analysis of the user entered corrections; and
utilizing the updated lexicon to improve accuracy of the transcription.

17. The computer implemented real-time voice transcription method according to claim 15, further comprising the step of identifying each speaker by outputting the transcription text in a unique format assigned to said speaker.

18. The computer implemented real-time voice transcription method according to claim 15, further comprising the steps of:
steering a signal reception pattern of a microphone array electronically to all directions simultaneously without any a-priori information about a signal's direction; and
extracting acoustic feature vectors from each of the directions, thereby facilitating positive identification of the speaker.

19. A computer product for real-time voice transcription, comprising a medium readable by a computer, the medium having a set of computer-readable instructions stored thereon executable by a processor when loaded into main memory, the instructions including:
a first set of instructions that, when loaded into main memory and executed by the processor, cause the processor to capture audio data, including speech information;
a second set of instructions that, when loaded into main memory and executed by the processor, cause the processor to extract temporal and aural features from the captured audio data;
a third set of instructions that, when loaded into main memory and executed by the processor, cause the processor to recognize the speech information within the audio data;
a fourth set of instructions that, when loaded into main memory and executed by the processor, cause the processor to identify a speaker during the speech recognition from the extracted temporal and aural features;
a fifth set of instructions that, when loaded into main memory and executed by the processor, cause the processor to produce a transcription of the identified speaker's speech;
a sixth set of instructions that, when loaded into main memory and executed by the processor, cause the processor to accept corrections to the transcription from a user;
a sixth set of instructions that, when loaded into main memory and executed by the processor, cause the processor to analyze the user entered corrections; and
a seventh set of instructions that, when loaded into main memory and executed by the processor, cause the processor to improve the speech recognition in real time based on the analysis.
wherein the transcription accuracy thereof is improved on the fly.

20. The computer product for real-time voice transcription according to claim 19, further comprising an eighth set of instructions that, when loaded into main memory and executed by the processor, cause the processor to identify the speaker from a composite signal containing a plurality of speakers.
